(19) United States
(12) Patent Application Publication
(10) Pub. No.: US 2009/0082008 A1
(43) Pub. Date: Mar. 26, 2009

(54) Mobile Phone Code Debugging Method and Apparatus

(76) Inventor: Per Thorell, Lund (SE)

Correspondence Address: COATS & BENNETT, PLLC, 1400 Crescent Green, Suite 300, Cary, NC, 27518, US

(21) Appl. No.: 11/859,023

(22) Filed: Sep. 21, 2007

(51) Int. Cl. H04Q 7/20

(52) U.S. Cl. 455/423

(57) ABSTRACT

Code stored at a mobile phone is debugged using a remote web browser interface. According to one embodiment, the mobile phone comprises a web server and a code debugger. The web server is configured to process an HTTP request generated by a remote HTTP client, the HTTP request including one or more code debugging commands. The code debugger is configured to debug code stored at the mobile phone based on the one or more code debugging commands using a program identified by the HTTP request. According to an embodiment of the remote HTTP client, the client comprises a web browser. The web browser is configured to generate the HTTP request for delivery to the mobile phone web server over a transport layer IP connection established with the web server. The HTTP request identifies the desired code debugging program stored at the mobile phone.

### BACKGROUND

The present invention generally relates to mobile phone software, and particularly relates to remotely debugging software stored on a mobile phone.

Software development is a complex process generally involving creating source code, debugging source code and compiling or interpreting debugged code into higher-level code. As used herein, the terms “code” and “source code” are interchangeable unless otherwise expressly noted and should be broadly interpreted to mean any sequence of statements and/or declarations written in any human-readable computer programming language such as C/C++, Java, BASIC, PERL, Python, Ruby, Smalltalk, Lisp, Boo, etc. Mobile phone software is conventionally debugged before installation on mobile phones.

Mobile phone software is typically debugged using software tools commonly referred to as debuggers. A debugger enables a developer to monitor the execution of a program, stop it, re-start it, run it in slow motion, and change values in memory. Software debuggers typically provide one or more of the following capabilities: setting dynamic breakpoints, watching for specified exceptions and conditions during code execution, stepping line-by-line through code during execution, counting how many times a statement has been processed, monitoring and altering program variables or storage in real time, etc.

Ideally, a software debugger recognizes when a bug occurs, isolates the source of the bug and identifies the cause. A ‘fix’ or ‘patch’ may then be determined to correct the bug. Mobile phone software debuggers conventionally simulate or emulate the mobile phone environment and often utilize the same software programs embedded in an actual mobile phone. This way, accurate debugging results are produced based on a more realistic view of the mobile phone system.

However, once software is loaded onto a mobile phone, the phone user conventionally has limited tools available to debug code. Some mobile phones have a script editor which may be used to view code written in high-level scripting languages such as, Python, Ruby, PERL, JavaScript, Rexx, Boo, etc. The phone user can manually debug code using the script editor by examining lines of code for bugs such as errors and malicious code. However, manual code debugging using a script editor is inefficient and error prone. Bugs are likely to be missed if the user does not carefully examine the entire code content. Further, the phone user must posses a detailed knowledge of the language syntax and rules in order to reliably debug the code. Even if these conditions are satisfied, bugs are still likely to be missed, thus requiring numerous debugging iterations. Also, conventional mobile phone debuggers requires special debugging equipment and are not remotely accessible, e.g., through a web browser interface. Conventional mobile phone debuggers are often connected to the mobile phone using a Joint Test Action Group (JTAG) interface (i.e., an IEEE 1149.1 interface). In many cases, the mobile phone cover has to be removed in order to access a hidden JTAG connector inside the phone. In some cases, the JTAG connector may also have been physically disabled or removed on mobile phones sold to consumers in order to prevent tampering of the mobile phone. In such cases, conventional debugging has to be performed on special development versions of the mobile phone.

### SUMMARY

According to the methods and apparatus taught herein, code stored at a mobile phone is debugged using a remote web browser interface. The mobile phone includes a web server and a code debugger. The mobile phone web server conforms to the HyperText Transfer Protocol (HTTP) in that the server receives HTTP requests and provides HTTP responses in turn. An HTTP request is generated by a remote web browser and is addressed to the mobile phone web server. The HTTP request includes code debugging commands input by a user of the web browser, e.g., by accessing a web page provided by the mobile phone web server. The debugging commands are directed to code stored at the mobile phone and packaged as an HTTP request which is sent to the mobile phone. The HTTP request also identifies a code debugger program maintained at the mobile phone for executing the debugging commands included in the HTTP request. The mobile phone code debugger debugs code text files or code stored in the mobile phone based on the commands extracted from the HTTP request. The HTTP request further includes a domain name or IP address identifying the web server.

The HTTP request is routed over the Internet or other packet-switched network to a packet-switched radio access network serving the mobile phone. The HTTP request is routed using the address included therein. The radio access network forwards the HTTP request to the mobile phone. The mobile phone web server recognizes that content of the HTTP request should be handled by the mobile phone code debugger. In one embodiment, the mobile phone web server extracts the code debugging commands from the HTTP request and notifies the code debugger. In another embodiment, the code debugger directly extracts the commands. Either way, the code debugger debugs code stored at the mobile phone based on the commands extracted from the HTTP request. This way, the mobile phone user or other authorized entity such as the phone manufacturer or a software developer may remotely debug code stored at the mobile phone by generating an HTTP request addressed to the web server.

According to one embodiment, the mobile phone comprises a web server and a code debugger. The web server is configured to process an HTTP request generated by a remote HTTP client, the HTTP request including one or more code debugging commands. The code debugger is configured to debug code stored at the mobile phone based on the one or more code debugging commands included in the HTTP request using a program identified by the HTTP request. According to an embodiment of a remote computer, the computer comprises a web browser. The web browser is configured to generate the HTTP request for delivery to the web server included in the mobile phone over a transport layer IP connection established with the web server. The HTTP request includes the one or more code debugging commands and identifies the corresponding mobile phone code debugging program.

Of course, the present invention is not limited to the above features and advantages. Those skilled in the art will recognize additional features and advantages upon reading the following detailed description, and upon viewing the accompanying drawings.

### BRIEF DESCRIPTION OF THE DRAWINGS

FIG. 1 is a block diagram of an embodiment of a mobile phone configured to debug code based on one or more code debugging commands received from a remote web browser.

FIG. 2 illustrates an embodiment of a web page accessed by a remote web browser for inputting code debugging commands to a mobile phone.

FIG. 3 illustrates an embodiment of processing logic for providing code debugging commands to a mobile phone via a remote web browser.

FIG. 4 illustrates an embodiment of processing logic for debugging code stored at a mobile phone based on debugging commands received from a remote web browser.

FIG. 5 is a block diagram of an embodiment of the mobile phone of FIG. 1.

### DETAILED DESCRIPTION

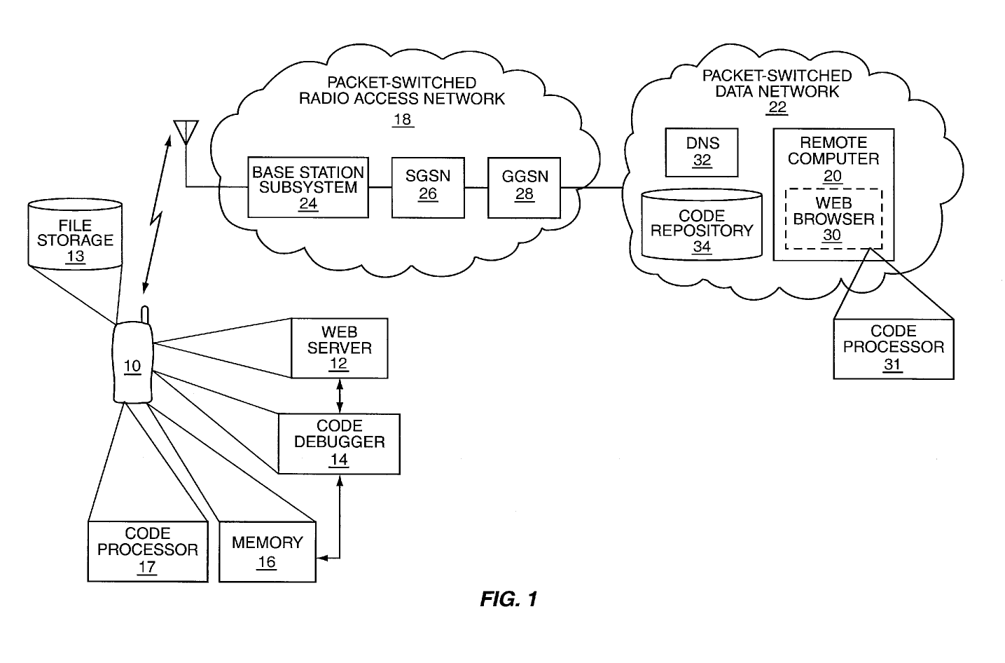

FIG. 1 illustrates an embodiment of a mobile phone 10 including a web server 12 and a code debugger 14. The web server 12 supports the Hypertext Transfer Protocol (HTTP) for enabling remote debugging of code stored in memory 16 included in the mobile phone 10. The web server 12 processes HTTP requests received from a packet-switched Radio Access Network (RAN) 18 serving the mobile phone 10. The HTTP requests are generated by a remote client computer 20 such as a PC or server having access to a packet-switched data network (PSDN) 22 such as the Internet. The remote computer 20 inserts code debugging commands in the HTTP requests.

The code debugging commands are directed to the mobile phone code debugger 14 and identify desired debugging tasks to be performed on code stored at the mobile phone 10. In one embodiment, the debugging commands cause the code debugger 14 to perform one or more tasks such as setting dynamic breakpoints, watching for specified exceptions and conditions during code execution, stepping line-by-line through code during execution, counting how many times a statement has been processed, monitoring and altering program variables or storage in real time, etc. The code debugger 14 or a code processor 17 may further process the code, e.g., by parsing or compiling the code. Regardless, code debugging commands included in an HTTP request received by the mobile phone 10 determine which debugging tasks are executed by the code debugger 14.

The HTTP requests are routed from the remote computer 20 to the mobile phone web server 12 over the PSDN 22 and packet-switched RAN 18. This way, the mobile phone user or other authorized entity such as the phone manufacturer or a trusted software developer may remotely debug code stored at the mobile phone 10 by including the appropriate code debugging commands in an HTTP request addressed to the web server 12. The code debugger 14 processes the commands and may convert the code debugging results into HyperText Markup Language (HTML) or Extensible Markup Language (XML) code. The HTML or XML code is embedded in a HTTP response message generated by the web sever 12 and sent to the remote computer 20 that sent the original HTTP request. This way, the remote user can view the code debugging results, which may be interactive as described in more detail later herein.

Mobile phone file storage 13 stores source code associated with applications running locally on the mobile phone 10. When an application is executed by the mobile phone 10, the corresponding code is loaded into mobile phone memory 16 and executed by the code processor 17. Program code stored in the file storage 13 may be debugged based on commands executed by the code debugger 14. The code debugger 14 may be integrated in the web server 12 or implemented as a separate entity, device or software program coupled to the web server 12. In one embodiment, the code debugger 14 is a code debugging program supported by the mobile phone 10. In another embodiment, the code debugger 14 is an interface to a code debugging program. Regardless, the code debugger 14 enables a user to remotely debug code stored at the phone 10. The interface that couples the code debugger 14 to the web server 12, may for example correspond to an interface such as a Java servlet, Common Gateway Interface (CGI), Simple CCGI (SCGI), FastCGI, Network layer Service Access Point Identifier (NSAPI), Internet Server Application Programming Interface (ISAPI), etc. or interfaces to server side scripting frameworks such as Active Server Pages (ASP), PHP, Ruby on Rails, JavaServer Pages (JSP) etc.

The mobile phone web server 12 recognizes HTTP requests addressed to the server 12 which include code debugging commands directed to the mobile phone code debugger 14. To this end, the web server 12 supports one or more interfaces for processing dynamic HTTP requests such as HTTP requests including code debugging commands. Each interface supported by the web server 12 enables the server 12 to extract code debugging commands included in an HTTP request and pass the extracted commands to the code debugger 14. Alternatively, the code debugger 14 directly extracts the debugging commands from the HTTP request. In either embodiment, the code debugger 14 debugs code stored at the mobile phone 10 based on the extracted commands.

The capability of the mobile phone web server 12 is limited only by the resources available to the mobile phone 10, e.g., memory bandwidth, communication bandwidth, processing power, etc. Minimally, the web server 12 functions as an HTTP server. However, the web server 12 may also function as an email server, Telnet server and/or File Transfer Protocol (FTP) server as mobile phone resources permit. The web server 12 is assigned an IP address for uniquely identifying the server 12. HTTP requests generated by the remote computer 20 are routed to the web server 12 based on the IP address included in the HTTP request. The packet-switched RAN 18 may comprise any type of packet-switched RAN such as a W-CDMA (Wideband Code Division Multiple Access) RAN, General Packet Radio Service/Enhanced Data rates for GSM Evolution (GPRS/EDGE), Wireless LAN, Bluetooth, WiMAX etc.

For ease of explanation only, operation of the packet-switched RAN 18 is described next with reference to a GPRS/EDGE RAN. FIG. 1 illustrates three nodes 24, 26, 28 included in the RAN 18 for supporting packet-switched communication, and particularly for supporting HTTP message routing between the mobile phone web server 12 and remote computer 20. The first node 24 is a Base Station Subsystem (BSS) for handling traffic and signaling between the mobile phone 10 and RAN 18. The BSS 24 transcodes speech channels, allocates radio channels, performs paging, manages quality of transmission and reception over the air interface and many other tasks related to the RAN 18 as is well known in the art. The second node 26 is a Serving GPRS support node (SGSN) for controlling connections between the RAN 18 and the mobile phone 10. The SGSN 26 performs session management and GPRS mobility management such as handovers and paging. The third node 28 is a Gateway GPRS Support Node (GGSN) for providing a gateway between the RAN 18 and the PSDN 22 and/or other GPRS networks (not shown). The GGSN 28 also assigns IP addresses to mobile phones served by the RAN 18 as is well known in the art. Accordingly, the GGSN 28 identifies HTTP requests addressed to the mobile phone web server 12 based on the IP address included in the request. The GGSN 28 forwards such HTTP requests to the SGSN 26 for delivery to the mobile phone web server 12 via the BSS 24.

HTTP requests addressed to the mobile phone web server 12 originate from the remote computer 20 which is connected to the PSDN 22. The remote computer 20 provides commands to the mobile phone 10 by first establishing a transport layer connection with the web server 12 such as a Transmission Control Protocol-Internet Protocol (TCP-IP) or User Datagram Protocol (UDP) connection. A transport layer connection may be established by identifying the address of the web server 12 and a particular port of the server 12. This information may be entered using a web browser 30 included in the remote computer 20. The default port for TCP-IP connections is port number 80. However, a different port may be used to increase security. Security may be further increased by establishing an HTTP connection over an encrypted Secure Sockets Layer (SSL) or Transport Layer Security (TLS) transport mechanism. An SSL or TLS based HTTP connection uses a different default port (port number 443) and an additional encryption/authentication layer between HTTP and TCP. Regardless, the mobile phone web server 12 monitors the port identified in the connection request.

The mobile phone web server 12 may require user authentication before processing HTTP requests, e.g., by requesting a user ID and password. This way, only authorized entities gain access to the mobile phone code debugger 14. After a transport layer connection is established, the web server 12 responds to the HTTP request, e.g., by sending an HTTP response to the computer's IP address provided as part of establishing the transport layer connection. The HTTP response includes a web page such as an HyperText Markup Language (HTML) or Extensible Markup Language (XML) document requested by the web browser 30. In one embodiment, the web page includes a list of debugging tasks supported by the code debugger 14. Broadly, the web page provides a mechanism for a user of the web browser 30 to input code debugging commands directed to the mobile phone code debugger 14.

Code debugging commands input by a user of the web browser 30 are included in an HTTP request which is sent from the remote computer 20 to the mobile phone web server 12. The HTTP request also identifies the mobile phone code debugger 14 and the source code stored at the mobile phone 10 to be debugged. The mobile phone code debugger 14 has access to all information in the HTTP request and debugs identified code based on the commands previously entered by the user via the web browser 30. This way, code debugging commands may be input using the remote web browser 30 and provided to the mobile phone 10 for subsequent processing. Accordingly, neither the remote computer 20 nor the web browser 30 directly debugs mobile phone code. The web browser 30 and computer 20 simply provide code debugging commands to the mobile phone 10 via HTTP requests.

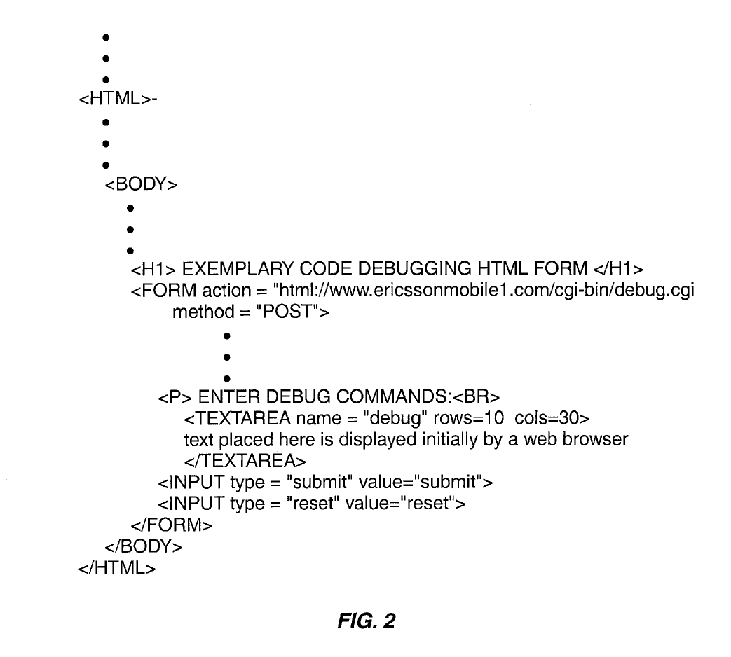

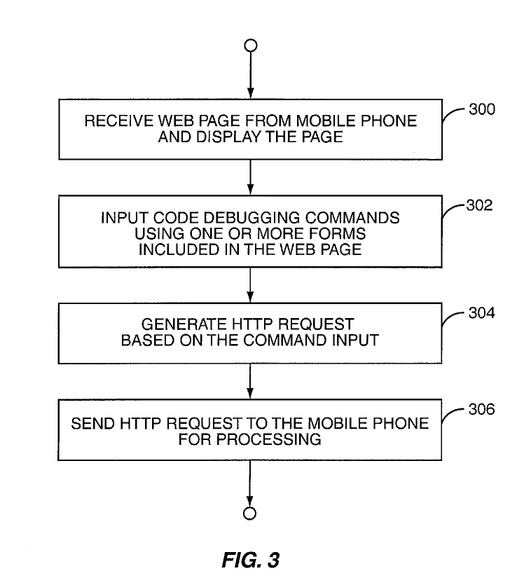

FIG. 2 illustrates one embodiment of an HTML-based web page provided by the mobile phone web server 12 to the remote web browser 30 for inputting code debugging commands. The web page may be generated by the code debugger 14, web server 12 or other application. Regardless, the web page is provided to the web browser 30 as part of an HTTP response generated by the web server 12. The web server 12 generates the HTTP response based on an HTTP request previously received from the web browser 30. The HTTP request solicits a web page for inputting code debugging commands. The web browser 30 receives the web page and displays it in a visually favorable manner, e.g., as illustrated by Step 300 of FIG. 3.

The web page includes an HTML document delimiter (<HTML>), a body section delimiter (<BODY>), a header (<H1>), and a form element (<FORM>). According to this embodiment, code debugging commands are input using the form element, e.g., as illustrated by Step 302 of FIG. 3. The form element includes an action attribute specifying a Uniform Resource Locator (URL) or Uniform Resource Identifier (URI). The URL/URI identifies the mobile phone code debugger 14 to which the form input is directed. In FIG. 2, the action attribute specifies an exemplary URL/URI of http://www.ericssonmobilel.com/cgi-bin that identifies an exemplary script-based debugging program named ‘debug.cgi’ stored in a ‘cgi-bin’ directory at the mobile phone 10.

The form element also includes a method attribute that specifies how debugging command information input to the form is transmitted to the mobile phone web server 12. In FIG. 2, the method attribute specifies an HTTP POST request which has no limits on the amount of data that can be included in the request. The POST request also causes the command input to be sent on a separate line from the URL/URI. Alternatively, the method attribute may specify an HTTP GET request. The GET request appends command input to the end of the URL/URI designated by the action attribute. Preferably, the POST request is used when a large amount of command input is expected, e.g., when several lines of debugging command input are expected.

The form element further includes one or more labels for directing a user of the web browser 30 where to enter one or more code debugging commands. In FIG. 2, an exemplary label “ENTER DEBUG COMMANDS:” is provided. This label alone may be sufficient for inputting debug commands when the mobile phone debugger 14 is a simple debugger program supporting a limited number of debug tasks. However, the form may include other command input options when the mobile phone debugger 14 is more complex. For example, labels identifying selectable debug features such as line-by-line debugging may be provided for ease of use.

In one embodiment, text input fields included in the form element provide a mechanism for entering code debugging commands into the form. In FIG. 2, a single TEXTAREA field is provided. The TEXTAREA field provides a multiple-line text input area for entering debug commands. The number of visible lines of text displayed by the web browser 30 is specified by the ‘rows’ attribute and the visible width of the text area is specified by the ‘cols’ attribute. Text initially displayed by the web browser 30 is placed between the start tag (<TEXTAREA>) and end tag (</TEXTAREA>) of the TEXTAREA field. The initial text may be overwritten by the browser 30. In one embodiment, the initial text provides a list of code debugging command options supported by the mobile phone code debugger 14. This way, a user of the web browser 30 may select from an initial list of debugging tasks by simply keeping the desired commands and deleting the others. A single-line text input field TEXT (not shown) may also be used for entering single debug commands. Both HTML and XML provide various types of fields for inputting debugging commands using the form element, e.g., push buttons, JavaScript buttons, radio buttons, check boxes, password fields, etc. This way, any desired type of code debugging task may be readily made available to the web browser user for selection.

Submit and reset buttons are also included in the form element. The reset button (<INPUT type=“reset” value=“reset”>) resets the values of all items in the form element to their original values when clicked or otherwise activated. The submit button (<INPUT type=“submit” value=“submit”>) causes the input entered in the form to be submitted. When the submit button is clicked or otherwise activated, an HTTP request is generated including the input entered in the form, e.g., as illustrated by Step 304 of FIG. 3. The HTTP request is addressed to the URL/URI specified by the ACTION attribute of the form element. The remote computer 20 then sends the HTTP request to the mobile phone web server 12 for processing, e.g., as illustrated by Step 306 of FIG. 3. In the present example, the debug command input to the form is processed by the ‘debug.cgi’ script identified by the URL/URI when the mobile phone 10 receives the HTTP request.

The specified URL/URI may include the domain name of the mobile phone web server 12 as shown in FIG. 2 (www.ericssonmobilel.com) or the corresponding IP address. Accordingly, the HTTP request is eventually routed to a Domain Name Server (DNS) 32 associated with the PSDN 22. The DNS 32 translates the domain name identified in the HTTP request to the IP address of the mobile phone web server 12 as is well known in the art. The HTTP request is then routed to the packet-switched RAN 18 based on the IP address. The GGSN 28 inspects the URI/URL, identifies the mobile phone web server 12 based on the IP address, and forwards the HTTP request to the mobile phone 10 via the SGSN 26 and BSS 24.

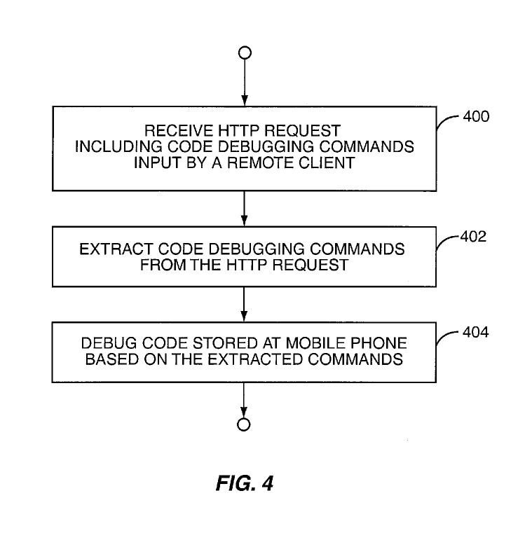

The mobile phone web server 12 receives the HTTP request from the BSS 24, e.g., as illustrated by Step 400 of FIG. 4. The web server 12 recognizes that the HTTP request is dynamic based on the URL/URI included in the request. That is, the web server 12 recognizes that the HTTP request is not simply requesting static web page content. Instead, the web server 12 recognizes that the HTTP request identifies the mobile phone code debugger 14. In FIG. 2, the mobile phone code debugger 14 corresponds to the script-based program named ‘debug.cgi.’ The web server 12 recognizes that the HTTP request is dynamic in this example because the conventional default CGI directory ‘cgi-bin’ is identified in the URL/URI. Broadly, the web server 12 may recognize a dynamic HTTP request based on the URL/URI address included in the request or any other mechanism included in the request.

The web server 12 or code debugger 14 extracts the code debugging commands included in the HTTP request in response to recognizing that the request is dynamic, e.g., as illustrated by Step 402 of FIG. 4. The extracted commands are stored in the mobile phone memory 16 for use by the code debugger 14. The code debugger 14 debugs code stored at the mobile phone 10 based on the extracted commands, e.g., as illustrated by Step 404 of FIG. 4. For example, based on FIG. 2, the code debugger 14 executes the ‘debug.cgi’ script stored at the mobile phone 10 based on the commands extracted from the HTTP request. Broadly, the HTTP request may identify any type of code debugging program supported by the mobile phone 10 such as a script-based program like Server Side Includes (SSI), PHP, Active Server Pages (ASP), PERL, Python, Ruby, Smalltalk, Lisp, Boo, etc. or even a compiled program such as an executable program or just-in-time compiled program. The mobile phone code debugger 14 may optionally embed the code debugging results in a web page for viewing by the remote web browser user. The web page is then packaged as an HTTP response generated by the web server 12 and sent to the remote computer 20 over a network layer connection established with the computer 20. The remote web browser 30 displays the code debugging results as a web page.

In one embodiment, the debugging results include output from the debugged code executed by the code processor 17. In another embodiment, the debugging results include an image or “screen dump” showing the content of the mobile phone display, or a part thereof. In another embodiment, the debugging results include output generated by the code debugger 14, e.g., a list of break points, stack trace shoving the contents of the call stack, error messages from the debugger, etc. In yet another embodiment, debugging results include the contents of a region in the mobile phone memory 16.

In some cases there may be a considerable time delay from when a code debugging command is received by the mobile phone code debugger 14 until the debugging results are available. It may, for example, take several hours from when a breakpoint is activated to when the code processor 17 reaches the break point. In such cases, the mobile phone debugger 14 may transmit an intermediate response and later, when the debugging results are available, send a notification to the computer 20, or optionally to another device. The notification message may contain the debugging results or may optionally contain an URL identifying an HTML document containing the debugging results. In some embodiments an HTML document containing the debugging results is stored in the file system 13. In other embodiments, the HTML document may be generated by the code debugger 14 when a HTTP request message containing the URL to the page is received by the web server 12. In one embodiment the notification messages are sent as SMS messages to a predefined phone number. In another embodiment the notification messages are sent as email messages to a predefined email address. In yet another embodiment, the notification messages are sent to a predefined user as instant messages using an instant messaging service such as MSN, ICQ, Google Talk or OMA IMPS.

The mobile phone code debugger 14 may optionally implement AJAX (Asynchronous JavaScript and XML) or other similar techniques for embedding debugging results in a web page. The mobile phone web server 12 generates an HTTP response including the embedded results and sends the HTTP response to the remote computer 20 over a network layer connection established with the computer 20. A code processor 31 included in or associated with the remote web browser 30 generates parts of the HTML code defining the web page. The browser code processor 31 may, based on the instructions in the embedded code, modify content of the web page in response to user input. The embedded code running on the browser code processor 31 may communicate with the mobile phone code debugger 14 by sending an XMLHttpRequest message. The browser code processor 31 may, based on the instructions in the embedded code, alter the code debugging tasks in response to a message generated by the mobile phone web server 12 and code debugger 14 after an XMLHttpRequest was received by the web server 12.

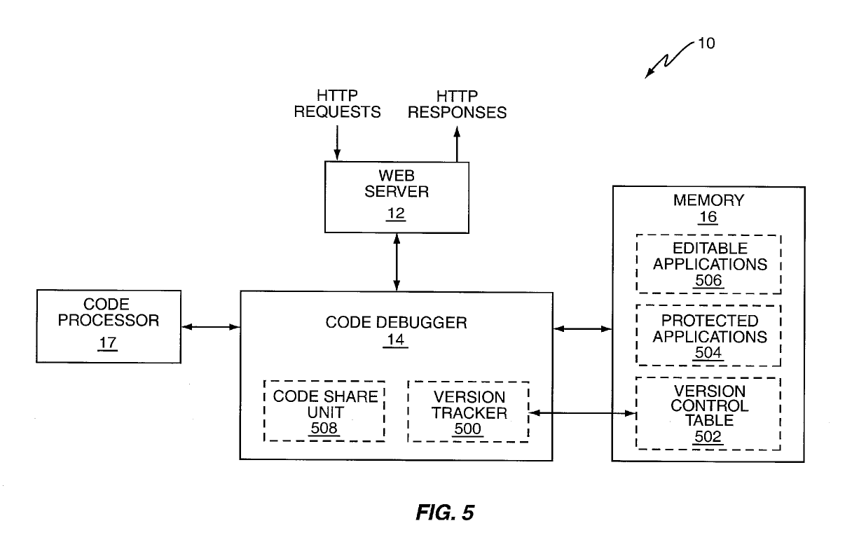

FIG. 5 illustrates an embodiment of the mobile phone 10. According to this embodiment, the web server 12 receives HTTP requests and sends HTTP responses as previously described. The web server 12 may be based on any conventional web server program such as the Apache HTTP server, the Internet Information Services (IIS) server, the Sun Java system server, the Zeus server, or the like. The code debugger 14 executes code debugging commands extracted from received HTTP requests also as previously described.

A code version tracker 500 is included in or associated with the code debugger 14. The code version tracker 500 maintains a table 502, e.g., in the mobile phone memory 16. The table 502 identifies different versions of the same code debugged by the code debugger 14. This way, a defective version of code may be replaced with a known good version. In one embodiment, a version of code found to have errors by the code debugger 500 is identified as defective in the table 504. If the code is subsequently accessed, the defective version is not used. Instead, only a valid version of the code is used. This way, the code version tracker 500 identifies different versions of the same code so that defective or otherwise undesirable versions of code may be replaced with an earlier or subsequent version of the code. In some embodiments, the code version tracker 500 is a revision control system such as CVS, SubVersion, GIT or ClearCase which stores the code belonging to different code revisions in the file storage 13.

The code debugger 14 may be prevented from accessing code associated with protected applications 504 such as a radio access protocol stack, TCP-IP protocol stack, media codecs, graphics libraries, mobile phone file system, etc. In one embodiment, a designated folder (not shown) is provided for storing code associated with debuggable applications 506 such as a menu system, phone book, Short Message Service (SMS) editor, Multimedia Messaging Service (MMS) editor, Wireless Access Protocol (WAP) browser, calendar, media player, email reader, RSS reader, etc. The code debugger 14 does not have access to code stored in other folders. In another embodiment, code associated with the protected applications 504 is stored in a restricted folder. In yet another embodiment, the code debugging capability of the mobile phone 10 is disabled by default. Accordingly, the mobile phone user must enable the code debugger 14 before using this feature. In one embodiment, a password is required to enable the code debugger 14.

A code share unit 508 included in or associated with the code debugger 14 enables the mobile phone 10 to share debugged code with other devices. The code share unit 508 may automatically send code stored in a predetermined folder such as a public folder to a remote code repository 34 addressable via the PSDN 22. In another embodiment, the mobile phone user manually selects which code is shared. Regardless, the code share unit 508 enables code sharing between the mobile phone 10 and the remote code repository 34. The code share unit 508 may also enable the mobile phone 10 to receive code from the remote code repository 34.

With the above range of variations and applications in mind, it should be understood that the present invention is not limited by the foregoing description, nor is it limited by the accompanying drawings. Instead, the present invention is limited only by the following claims, and their legal equivalents.

What is claimed is:

1. In a mobile phone, a method of debugging code comprising:
receiving a hypertext transfer protocol (HTTP) request generated by a remote HTTP client, the HTTP request including one or more code debugging commands; and
debugging code stored at the mobile phone based on the one or more code debugging commands included in the HTTP request using a program identified by the HTTP request.

2. The method of claim 1, wherein receiving the HTTP request comprises receiving at least one of an HTTP GET request, an HTTP POST request, and an XMLHttpRequest.

3. The method of claim 1, wherein debugging the code stored at the mobile phone comprises executing the program identified by the HTTP request based on the one or more code debugging commands included in the HTTP request.

4. The method of claim 1, further comprising sending an HTTP response to the remote HTTP client, the HTTP response including code debugging results generated in response to the HTTP request.

5. The method of claim 4, wherein the code debugging results include at least one of output from the program used to debug the code, a screen dump from the mobile phone, and output generated by the debugged code during execution.

6. The method of claim 1, further comprising authenticating the remote HTTP client before processing the HTTP request.

7. The method of claim 1, further comprising deactivating the program identified by the HTTP request unless the program is activated by a user of the mobile phone.

8. The method of claim 1, further comprising tracking different versions of debugged code.

9. The method of claim 1, further comprising registering debugged code with a remote code repository.

10. The method of claim 1, wherein the HTTP request is based on a URL generated by the mobile phone.

11. The method of claim 1, wherein one or more of the code debugging commands comprises a command for setting a break point.

12. The method of claim 1, further comprising sending a notification message responsive to one or more of the code debugging commands being completed.

13. The method of claim 12, wherein the notification message comprises one of a URL identifying code debugging results, an SMS message, an email message, or an instant messaging message.

14. A mobile phone, comprising:
a web server configured to process a hypertext transfer protocol (HTTP) request generated by a remote HTTP client, the HTTP request including one or more code debugging commands; and
a code debugger configured to debug code stored at the mobile phone based on the one or more code debugging commands included in the HTTP request using a program identified by the HTTP request.

15. The mobile phone of claim 14, wherein the web server is configured to receive at lest one of an HTTP GET request including the one or more code debugging commands, an HTTP POST request including the one or more code debugging commands, and an XMLHttpRequest including the one or more code debugging commands.

16. The mobile phone of claim 14, wherein the code debugger is configured to execute the program identified by the HTTP request based on the one or more code debugging commands included in the HTTP request.

17. The mobile phone of claim 14, wherein the web server is further configured to send an HTTP response to the remote HTTP client, the HTTP response including code debugging results generated in response to the HTTP request.

18. The mobile phone of claim 14, wherein the web server is further configured to authenticate the remote HTTP client before processing the HTTP request.

19. The mobile phone of claim 14, wherein the web server is further configured to send a notification message responsive to one or more of the code debugging commands being completed.

20. The mobile phone of claim 14, further comprising a code tracker configured to track different versions of debugged code.

21. A method of remotely debugging mobile phone code, comprising:
establishing a transport layer internet protocol (IP) connection with a web server included in a mobile phone; and
sending a hypertext transfer protocol (HTTP) request to the web server over the transport layer IP connection, the HTTP request identifying a program stored at the mobile phone configured to debug code stored at the mobile phone based on one or more code debugging commands included in the HTTP request.

22. The method of claim 21, further comprising processing an HTTP response received from the web server included in the mobile phone, the HTTP response including code debugging results generated in response to the HTTP request.

23. A computer for remotely debugging mobile phone code, the computer comprising a web browser configured to generate a hypertext transfer protocol (HTTP) request for delivery to a web server included in a mobile phone over a transport layer internet protocol (IP) connection established with the web server, the HTTP request identifying a program stored at the mobile phone configured to debug code stored at the mobile phone based on one or more code debugging commands included in the HTTP request.

24. The computer of claim 23, wherein the web browser is further configured to process an HTTP response received from the web server included in the mobile phone, the HTTP response including code debugging results generated in response to the HTTP request.
